(19) United States
(12) Patent Application Publication
(10) Pub. No.: US 2026/0330666 A1
(43) Pub. Date: Oct. 22, 2026

(54) PROFILER

(71) Applicant: Keyence Corporation, Osaka (JP)

(72) Inventor: Takashi ATORO, Osaka (JP)

(73) Assignee: Keyence Corporation, Osaka (JP)

(21) Appl. No.: 19/560,194

(22) Filed: Mar. 9, 2026

(30) Foreign Application Priority Data
Apr. 16, 2025 (JP) 2025-067292
Nov. 28, 2025 (JP) 2025-209216

(51) Int. Cl. G06T 7/60; G06V 10/145

(52) U.S. Cl. CPC G06T 7/60; G06V 10/145

(57) ABSTRACT

A profiler is provided to obtain highly accurate three-dimensional data. The profiler includes: a first imaging element and a second imaging element that capture measurement light in directions different from each other; a generation unit that generates a first height profile on the basis of an image of the measurement light captured by the first imaging element and generates a second height profile on the basis of an image of the measurement light captured by the second imaging element; and a correction unit that, on the basis of the first height profile and the second height profile, dynamically corrects one of the first height profile and the second height profile such that the first height profile and the second height profile are in a positionally-aligned relationship, and thus generates an aligned first height profile and an aligned second height profile.

### CROSS-REFERENCE TO RELATED APPLICATIONS

The present application claims foreign priority based on Japanese Patent Application No. 2025-067292, filed April 16, 2025, and No. 2025-209216, filed November 28, 2025, the contents of which are incorporated herein by references.

### BACKGROUND OF THE INVENTION

### 1. Technical Field

The present disclosure relates to a profiler that generates a height profile.

### 2. Description of the Related Art

For example, JP 2017-151067 A discloses a profiler that irradiates a measuring object with measurement light in two directions, receives the measurement light reflected from the measuring object, and generates a height profile of the measuring object on the basis of intensity of the received measurement light.

By combining pieces of profile information in two directions to generate the height profile as described in JP 2017-151067 A, it is possible to obtain a three-dimensional image with a reduced blind spot.

However, an error occurs in a measured value when, for example, an emission angle of the measurement light changes, a position and an orientation of an imaging optical system change, or an installation state changes, due to a temperature or a change with time.

Here, in the case of generating the height profile based on the profile information in a single direction, similar errors occur in the entire profile and, thus, relative errors in a three-dimensional image are not so large.

On the other hand, in the case where pieces of profile information in two directions are acquired, errors may occur differently from the case of generating the height profile based on the profile information in a single direction and, thus, combining the pieces of the profile information could result in large errors.

### SUMMARY OF THE INVENTION

The present disclosure has been made in view of such a point, and an object of the present disclosure is to obtain highly accurate three-dimensional data by dynamically correcting errors in pieces of profile information in directions different from each other.

In order to achieve the above object, an aspect of the present disclosure can be based on a profiler that projects line light as measurement light and generates a height profile on the basis of an image obtained by capturing an image of the measurement light.

The profiler includes: a light projection unit configured to project line light as measurement light; a first imaging element and a second imaging element configured to capture an image of the measurement light in directions different from each other; a generation unit configured to generate a first height profile on the basis of an image of the measurement light captured by the first imaging element and generate a second height profile on the basis of an image of the measurement light captured by the second imaging element; and a correction unit configured to, on the basis of the first height profile and the second height profile generated by the generation unit, dynamically correct at least one of the first height profile or the second height profile such that the first height profile and the second height profile are in a positionally-aligned relationship, and thus to generate an aligned first height profile and an aligned second height profile.

According to the above configuration, since the first imaging element and the second imaging element that capture an image of the measurement light in directions different from each other are provided, it is possible to obtain a three-dimensional image with a reduced blind spot. It is possible to dynamically correct at least one of the first height profile generated on the basis of the image of the measurement light captured by the first imaging element or the second height profile generated on the basis of the image of the measurement light captured by the second imaging element so that the first height profile and the second height profile are in a positionally-aligned relationship, and to generate the aligned first height profile and the aligned second height profile.

As described above, since the correction unit that dynamically corrects at least one of the first height profile or the second height profile is provided, highly accurate three-dimensional data can be obtained.

### BRIEF DESCRIPTION OF THE DRAWINGS

FIG. 1 is a diagram for explaining an operation of a profiler according to a first embodiment of the present invention;

FIG. 2 is a block diagram of a profiler;

FIG. 3A is a view illustrating an example of a measuring object;

FIG. 3B is a view illustrating an example in which a measuring object is measured by the first head unit;

FIG. 3C is a view illustrating an example in which the measuring object is measured by the second head unit;

FIG. 4 is a flowchart illustrating a flow of processing performed by a profiler;

FIG. 5A is a view illustrating a state in which a certain height profile is designated;

FIG. 5B is a diagram illustrating a case where a characteristic region corresponding to the X-direction correction is designated on the profile image;

FIG. 5C is a diagram illustrating a case where one characteristic region corresponding to the Z-direction correction are designated on the profile image;

FIG. 5D is a view illustrating a case where a plurality of characteristic regions corresponding to the Z-direction correction are designated on the profile image;

FIG. 6A is a view illustrating a case where a characteristic region corresponding to the X-direction correction is designated on the three-dimensional height image;

FIG. 6B is a view illustrating a case where two characteristic regions corresponding to the Z-direction correction are designated on the three-dimensional height image;

FIG. 6C is a view illustrating a case where a plurality of characteristic regions corresponding to the Z-direction correction are designated on the three-dimensional height image;

FIG. 7 is a flowchart illustrating a processing procedure in a case of automatically recognizing a characteristic region;

FIG. 8 is a flowchart illustrating a procedure of dynamic correction processing based on a three-dimensional height image;

FIG. 9 is a time chart at the time of operation of the profiler;

FIG. 10 is a flowchart illustrating a procedure of dynamic correction processing based on a height profile image; and

FIG. 11 is a view corresponding to FIG. 2 according to a second embodiment of the present invention.

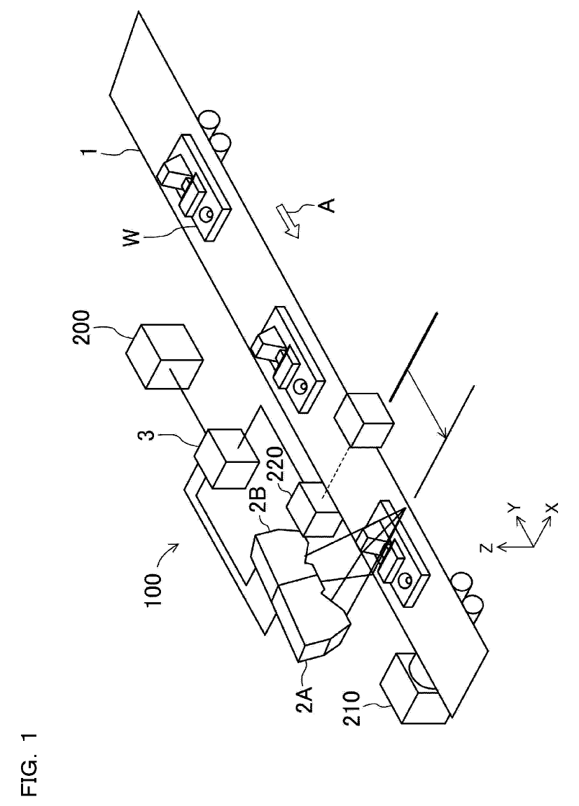

### DETAILED DESCRIPTION

Hereinafter, embodiments of the present invention will be described in detail with reference to the drawings. It is to be noted that the following description of preferred embodiments is merely exemplary in nature and is not intended to limit the present invention, its application, or its use. For example, the relative size and positional relationship of each member illustrated in the drawings are for describing one embodiment, and do not limit the present invention.

### First embodiment

The profiler 100 generates a height profile of the measuring object W conveyed by the conveying device 1 by image processing. The profiler 100 includes a first head unit 2A, a second head unit 2B, and a controller unit 3 that performs image processing on images obtained by the first head unit 2A and the second head unit 2B. The profiler 100 is a device in which the first head unit 2A and the second head unit 2B project line light as measurement light onto the measuring object W and generate a height profile corresponding to the measurement light on the basis of an image obtained by capturing an image of the measurement light projected onto the measuring object W. The controller unit 3 is configured to generate a height profile of the measuring object W on the basis of the images obtained by the first head unit 2A and the second head unit 2B. The controller unit 3 outputs, for example, a generated result, a profile, and the like. The conveyance device 1 includes a conveyor or the like controlled by a programmable logic controller (PLC) 200.

The moving direction of the measuring object W by the conveying device 1 is indicated by a white arrow A. In the present embodiment, a direction along a moving direction of the measuring object W by the conveying device 1 is a Y direction, a width direction of the conveying device 1 is an X direction, and a height direction is a Z direction. The X direction and the Y direction are orthogonal to each other, and the Z direction is orthogonal to the XY plane. The first head unit 2A and the second head unit 2B may be moved in the Y direction without moving the measuring object W by the conveying device 1.

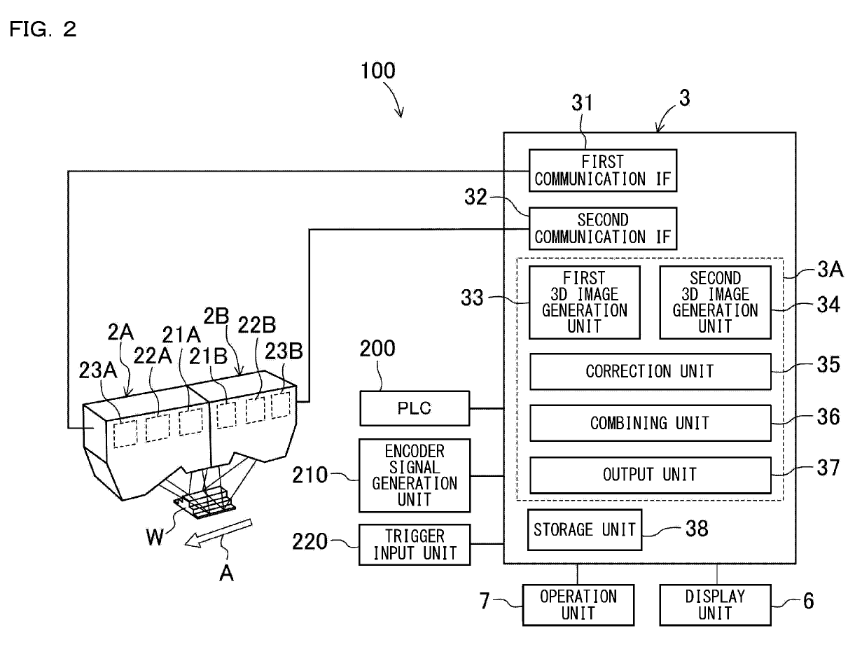

As illustrated in FIG. 2, the controller unit 3 includes a first communication interface 31, a second communication interface 32, a first three-dimensional (3D) image generation unit 33, a second 3D image generation unit 34, a correction unit 35, a combining unit 36, and an output unit 37. The PLC200, the encoder signal generation unit 210 of the conveyance device 1, and the trigger input unit 220 are connected to the controller unit 3.

The encoder signal generation unit 210 includes a device or the like that outputs a signal indicating an operation state of the conveyance device 1. A typical example of the encoder signal generation unit 210 is a rotary encoder provided on the rotation shaft of the conveyance device 1. When a signal from the encoder signal generation unit 210 is input to the controller unit 3, the controller unit 3 can grasp that the measuring object W is being conveyed by the conveyance device 1 or that the conveyance of the measuring object W is stopped. The trigger input unit 220 is a device for indicating image capture timing of the measuring object W by the first head unit 2A and the second head unit 2B to the controller unit 3. A typical example of the trigger input unit 220 is a photoelectric sensor or the like disposed on the conveyance device 1. By receiving the trigger signal from the trigger input unit 220 by the controller unit 3, it is possible to detect that the measuring object W has been conveyed and to define timing of performing processing such as imaging and profile generation.

As illustrated in FIG. 2, the profiler 100 includes a display unit 6 and an operation unit 7. The operation unit 7 is a member for performing various operations and settings on the controller unit 3, and a keyboard, a console, a pointing device such as a mouse, or the like can be used.

The display unit 6 is a device for displaying the generated profile, the three-dimensional height image, the luminance image, a setting screen for performing various settings, an input value input from the operation unit 7 on the setting screen, or the like. Such a display unit 6 includes various display devices.

The controller unit 3 includes a control unit 3A and a storage unit 38. The control unit 3A includes, for example, a microcomputer including a central processing unit, a ROM, a RAM, and the like. The control unit 3A configures a first 3D image generation unit 33, a second 3D image generation unit 34, a correction unit 35, a combining unit 36, and an output unit 37. Some or all of the first 3D image generation unit 33, the second 3D image generation unit 34, the correction unit 35, the combining unit 36, and the output unit 37 may be configured by hardware of the control unit 3A, or may be configured by a combination of hardware and software.

The storage unit 38 stores, for example, a program executed by the control unit 3A, images obtained by the first head unit 2A and the second head unit 2B, profile data, setting information, correction information, and the like. The storage unit 38 includes, for example, a recording medium such as a nonvolatile memory or a hard disk.

### Head Part

The first head unit 2A is disposed above the measuring object W, and is operated by an imaging instruction signal transmitted from the controller unit 3. The imaging intervals in the Y direction may be equal in the time direction, or a signal from the encoder signal generation unit 210 that detects the conveyance state (movement amount) of the measuring object W may be input so that the movement amount of the measuring object W from the previous imaging to the current imaging becomes equal.

The first head unit 2A is a member for measuring the height profile of the measuring object W from above, and forms one form of a first light projecting/receiving unit. The position of the first head unit 2A with respect to the measuring object W is not limited to the upper side of the measuring object W, and may be a side or a lower side.

As shown in FIG. 2, the first head unit 2A includes a first light projection unit 21A that projects line light as measurement light onto the measuring object W relatively moved in one direction (conveying direction A), a first light receiving unit (first imaging element) 22A that detects reflected light projected and reflected by the first light projection unit 21A onto the measuring object W to capture an image of the measurement light, and a first profile generator 23A for generating a height profile indicating a cross-sectional shape of the measuring object W based on detection data acquired by the first light receiving unit 22A. The first light projection unit 21A is made of, for example, a member that emits laser light. The longitudinal direction of the line light is a direction orthogonal to the conveyance direction A, that is, the X direction. The "height direction" is used to mean a distance direction between the first head unit 2A (more precisely, the first light receiving unit 22A) and the measuring object W.

In the first head unit 2A, the first light projection unit 21A irradiates the conveyed measuring object W1 with line light in the X-axis direction, and the first light receiving unit 22A receives the reflected light, so that the first profile generator 23A generates the first height profile as data indicating the two-dimensional cross-sectional shape of the measuring object W. At this time, the measuring object W is virtually cut by a cut surface parallel to the XZ plane, and an outer shape (outer edge) of the cut surface becomes a first height profile. The height profile is a distance (distance in the Z-axis direction) from the first head unit 2A to a measurement point of the measuring object W, and includes a set of values of the height Z at each point X coordinate of a plurality of points along the X direction (longitudinal direction of the line light). When the height profile is used for the height image, points at which the points are equally spaced in the X direction are selected.

The second head unit 2B can also adopt substantially the same configuration as the first head unit 2A described above. That is, the second head unit 2B is one form of a second light projecting/receiving unit, and includes a second light projection unit 21B that projects line light as measurement light to the measuring object W relatively moved in one direction (conveyance direction A), a second light receiving unit (second imaging element) 22B that captures an image of the measurement light by detecting reflected light projected and reflected from the second light projection unit 21B to the measuring object W, and a second profile generator 23B that generates a height profile indicating a cross-sectional shape of the measuring object W based on detection data acquired by the second light receiving unit 22B. The second profile generator 23B generates a second height profile as data indicating the two-dimensional cross-sectional shape of the measuring object W. The second head unit 2B is also operated by the imaging instruction signal transmitted from the controller unit 3.

In the present embodiment, when the profiler 100 is in operation, the first head unit 2A and the second head unit 2B are arranged side by side in the conveying direction A. Specifically, the first head unit 2A is disposed on the downstream side in the conveyance direction A, and the second head unit 2B is disposed on the upstream side in the conveyance direction A. Then, the first light receiving unit 22A of the first head unit 2A takes a posture from the downstream side to the upstream side in the conveyance direction A with respect to the measuring object W. The second light receiving unit 22B of the second head unit 2B is in an attitude from the upstream side to the downstream side in the conveyance direction A with respect to the measuring object W. Therefore, the first light receiving unit 22A of the first head unit 2A and the second light receiving unit 22B of the second head unit 2B capture an image of the measurement light in directions different from each other so as to capture the image of the measurement light in two directions.

At any given time or in a signal from the encoder signal generation unit 210, the measurement target positions measured by the first head unit 2A and the second head unit 2B are different in the Y direction and, thus, it is necessary to calculate the misalignment in the Y direction. For example, a relative misalignment in the Y direction between the first head unit 2A and the second head unit 2B is acquired using a three-dimensional height image based on detection data acquired by the first head unit 2A and the second head unit 2B. Examples of a method of calculating the misalignment in the Y direction include a method using pattern matching or the like.

For example, in the case of a long measuring object W having no break in the three-dimensional height image, a delay time from timing of receiving the imaging instruction signal to actual imaging may be provided for one head unit so that the position of the profile can be aligned in advance.

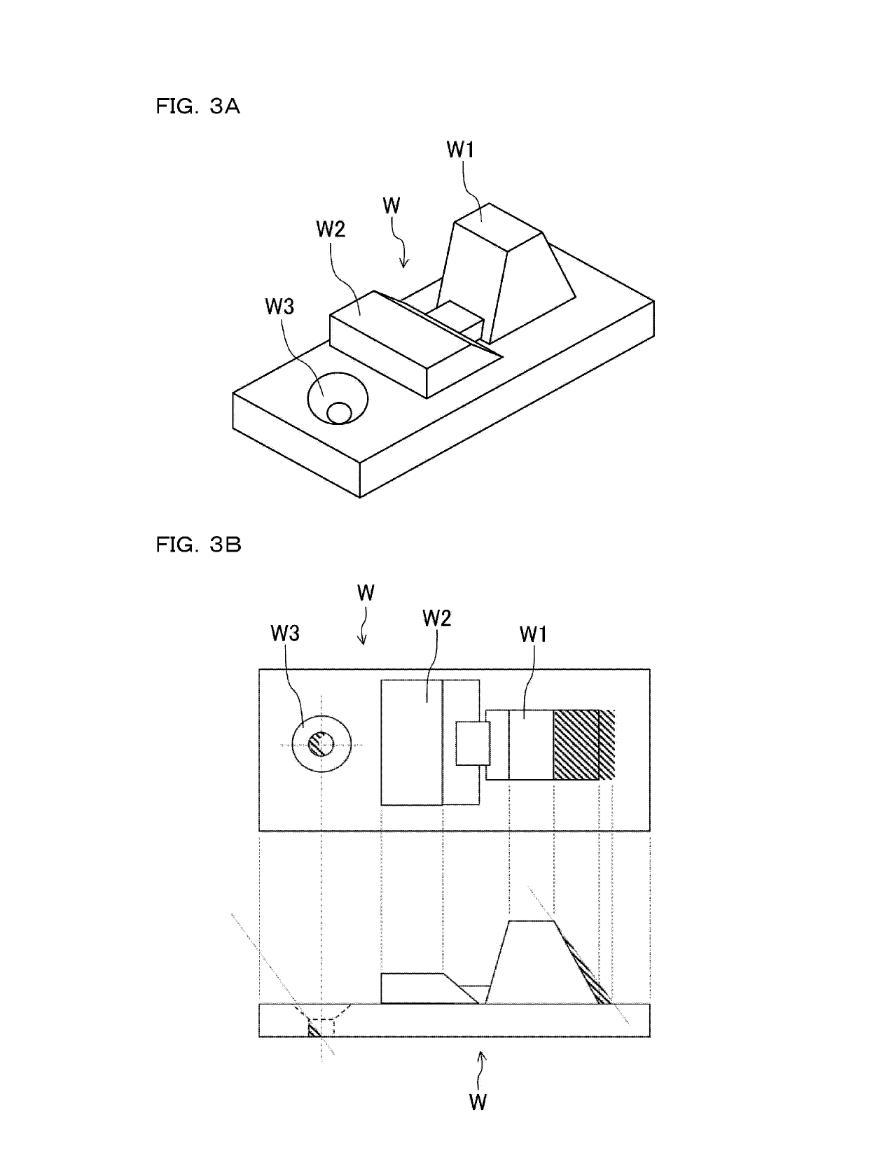

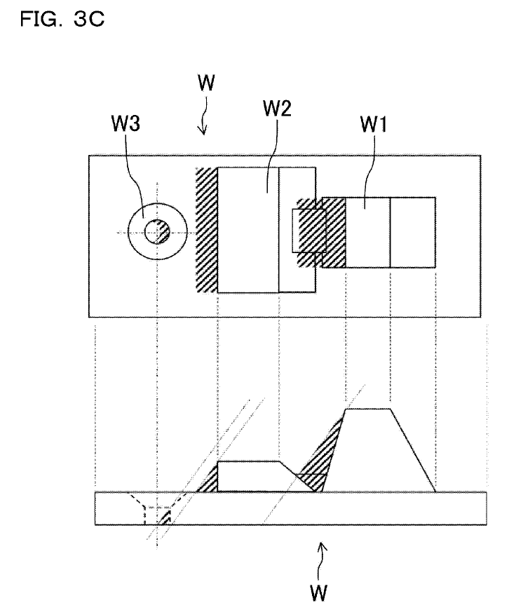

Here, a case of measuring the measuring object W as illustrated in FIG. 3A is assumed. In the case of measuring the measuring object W having the convex portions W1 and W2 and the concave portion W3, a blind spot is easily formed. FIG. 3B shows an example of measurement by the first head unit 2A, and the shaded portion in FIG. 3B corresponds to a blind spot of the first head unit 2A. On the other hand, FIG. 3C shows an example of measurement by the second head unit 2B, and the shaded portion in FIG. 3C corresponds to a blind spot of the second head unit 2B. As described above, since the blind spot when measured by the first head unit 2A is different from the blind spot when measured by the second head unit 2B, a three-dimensional height image with a reduced blind spot can be obtained by combining the first height profile obtained by the first head unit 2A and the second height profile obtained by the second head unit 2B.

However, an error may occur in a measured value when, for example, an emission angle of the line light changes, a position and an orientation of an imaging optical system change, or an installation state changes due to a temperature or a change with time. In the case of a profile measured in a single direction, similar errors occur in the entire profile and, thus, relative errors in the three-dimensional height image are not so large; however, in the case of a profile in two directions which may have errors occurring differently, combining the pieces of profile information results in large errors. On the other hand, the controller unit 3 according to the present embodiment has a correction function of dynamically correcting at least one of the first height profile or the second height profile used for combining.

### Details of Controller Unit 3

The first communication interface 31 of the controller unit 3 is a part that receives the first height profile data obtained by the first head unit 2A and an image (first raw image) before generation of the first height profile, and transmits an imaging instruction signal to the first head unit 2A. In addition, the second communication interface 32 is a part that receives the second height profile data obtained by the second head unit 2B and an image (second raw image) before generation of the second height profile, and transmits an imaging instruction signal to the second head unit 2B.

The first 3D image generation unit 33 is a part that generates a three-dimensional height image on the basis of the first height profile data obtained by the first head unit 2A. The second 3D image generation unit 34 is a part that generates a three-dimensional height image on the basis of the second height profile data obtained by the second head unit 2B.

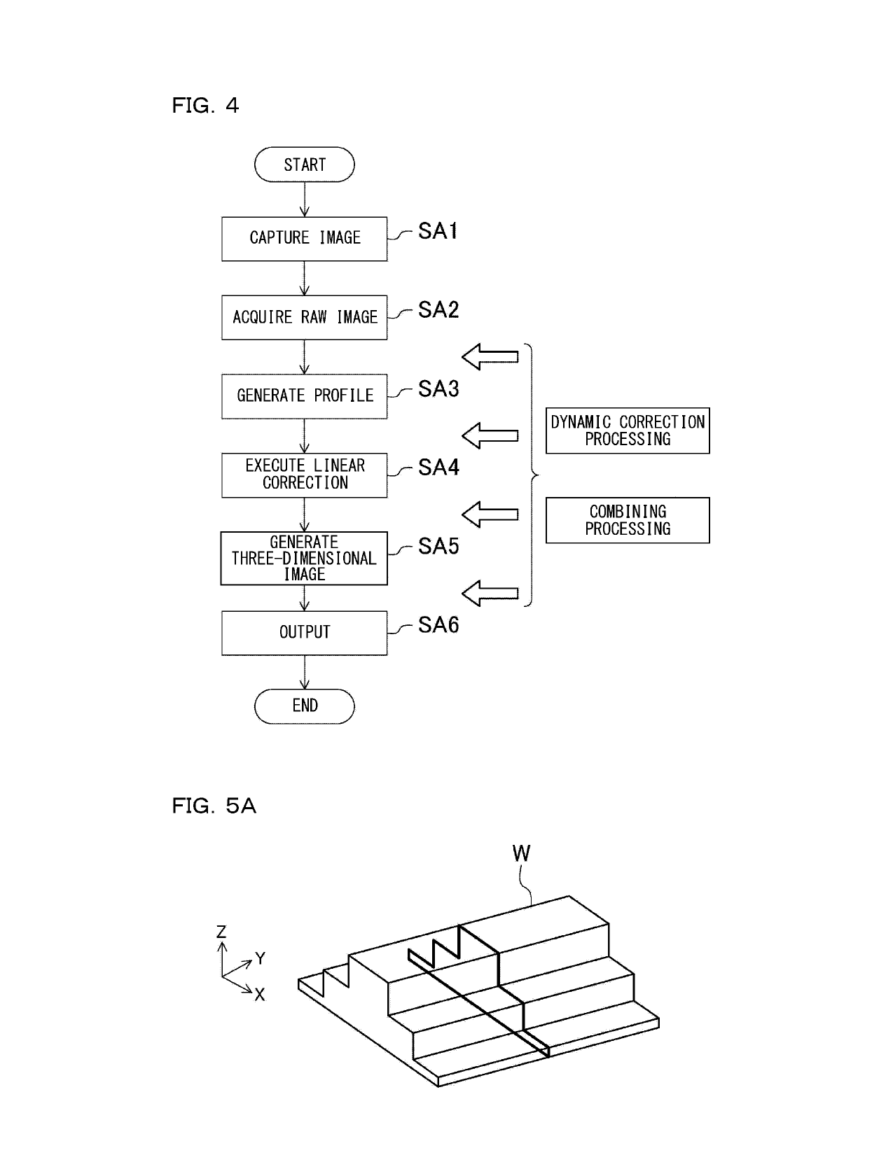

FIG. 4 is a flowchart illustrating a flow of processing performed by the profiler 100. In step SA1, the first light receiving unit 22A of the first head unit 2A and the second light receiving unit 22B of the second head unit 2B capture the line light projected onto the measuring object W. As a result, the first raw image and the second raw image are generated. In step SA2, the first profile generator 23A and the second profile generator 23B acquire the first raw image and the second raw image, respectively. In step SA3, the first profile generator 23A and the second profile generator 23B generate a first height profile and a second height profile, respectively. In step SA4, the correction unit 35 executes the linear correction processing on the first height profile and the second height profile. The linear correction processing is correction of a measurement result due to a temperature or a temporal change.

In the UV coordinate system of the first light receiving unit 22A and the second light receiving unit 22B, in the V direction (the height Z direction in the real space), the closer to the first light receiving unit 22A and the second light receiving unit 22B, the denser the interval between the X coordinates is measured, and the farther away from the first light receiving unit 22A and the second light receiving unit 22B, the sparser the interval between the X coordinates is measured. Therefore, points at which the points are equally spaced in the X direction are selected, and the height Z at the point can be obtained by interpolation from the measured heights Z at the surrounding points.

In step SA5, on the basis of the first height profile and the second height profile after the linear correction, the first 3D image generation unit 33 and the second 3D image generation unit 34 generate a three-dimensional height image.

Although the step of the dynamic correction processing by the correction unit 35 and the step of the combining processing by the combining unit 36 are not included in the flowchart illustrated in FIG. 4, these two steps can be included, for example, between step SA2 and step SA3, between step SA3 and step SA4, between step SA4 and step SA5, and between step SA5 and step SA6.

In the present embodiment, an example in which the correction unit 35 and the combining unit 36 are provided in the controller unit 3 has been described, but the present invention is not limited thereto, and the correction unit 35 and the combining unit 36 may be provided in the first head unit 2A or the second head unit 2B.

The combining processing by the combining unit 36 is processing of combining a first height profile generated on the basis of the image of the measurement light captured by the first light receiving unit 22A and a second height profile generated on the basis of the image of the measurement light captured by the second light receiving unit 22B.

Furthermore, the dynamic correction processing performed by the correction unit 35 is processing of dynamically correcting at least one of the first height profile or the second height profile used for combining by the combining unit 36, on the basis of the first height profile generated on the basis of the image of the measurement light captured by the first light receiving unit 22A and the second height profile generated on the basis of the image of the measurement light captured by the second light receiving unit 22B. Details of these processes will be described later.

In step SA6 of FIG. 4, the output unit 37 outputs the height profile combined by the combining unit 36, the first height profile generated on the basis of the image of the measurement light captured by the first light receiving unit 22A, and the second height profile generated on the basis of the image of the measurement light captured by the second light receiving unit 22B. The output unit 37 may output to, for example, the display unit 6 or the storage unit 38. The display unit 6 can display the height profile output from the output unit 37. The storage unit 38 can store the height profile output from the output unit 37.

The correction unit 35 calculates a change amount not only from the height profile but also from the first raw image output from the first light receiving unit 22A and then from the generated three-dimensional height image to obtain an aligning parameter as a correction value, and calculates a change amount from the second raw image output from the second light receiving unit 22B and then from the generated three-dimensional height image to obtain an aligning parameter as a correction value. The target image for which the change amount is calculated may be the entire image or a partial characteristic region. The characteristic region can be acquired by both the first head unit 2A and the second head unit 2B, and can be a region with little shape change, but is not limited thereto.

The characteristic region can be designated by both the user and the automatic recognition. The direction of correction by the correction unit 35 includes, for example, the X direction, the Z direction, the θ direction, or the Z direction for an offset and a span. Timing for the correction unit 35 to generate the correction value (aligning parameter) may be, for example, at each profile, each three-dimensional height image, or any given period (time). For example, the correction unit 35 may individually hold the temperature characteristic value as a correction value in advance.

The combining unit 36 applies the amount of change calculated by the correction unit 35 not only to the height profile but also to the raw image and the three-dimensional height image to execute the combining processing. The application target of the change amount may be all the light receiving units 22A and 22B, or may be a light receiving unit serving as a slave excluding one light receiving unit serving as a master (reference). Either the first light receiving unit 22A or the second light receiving unit 22B may be set as a master. For example, in the case of correction in the X direction, processing of shifting the height data and the luminance data in the X direction by the same amount may be executed. In addition, the correction value is applied to the entire height profile, the entire raw image, and the entire three-dimensional height image even if a partial region is used at the time of calculating the correction value. Since the combining timing by the combining unit 36 follows timing at which the correction value is generated, the combining processing is executed after the correction value is generated. The correction value may include a temperature characteristic value. When the temperature characteristic value is used as the correction value, the temperature characteristic value is applied in accordance with the temperature change of the first head unit 2A and the second head unit 2B.

Details of a case of correcting a positional misalignment between the first head unit 2A and the second head unit 2B due to a temperature or a change with time and a deviation in measurement results of the first head unit 2A and the second head unit 2B caused by a misaligned optical systems inside the first head unit 2A and the second head unit 2B will be described.

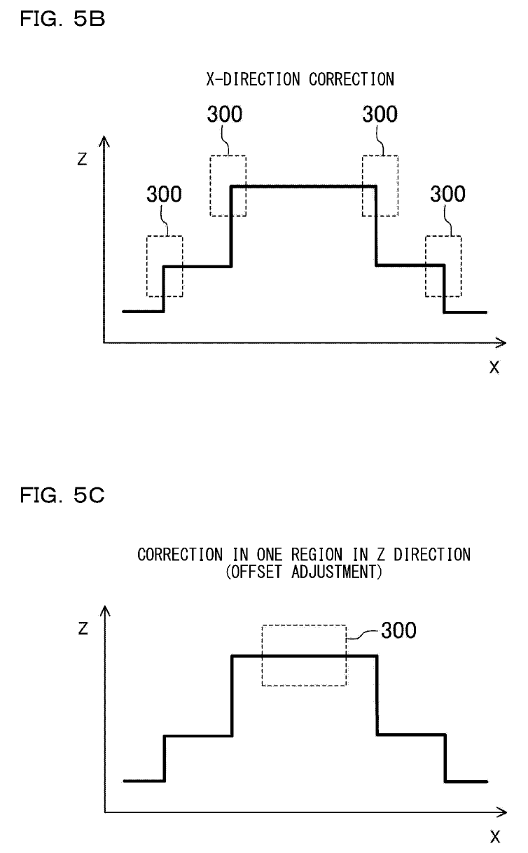

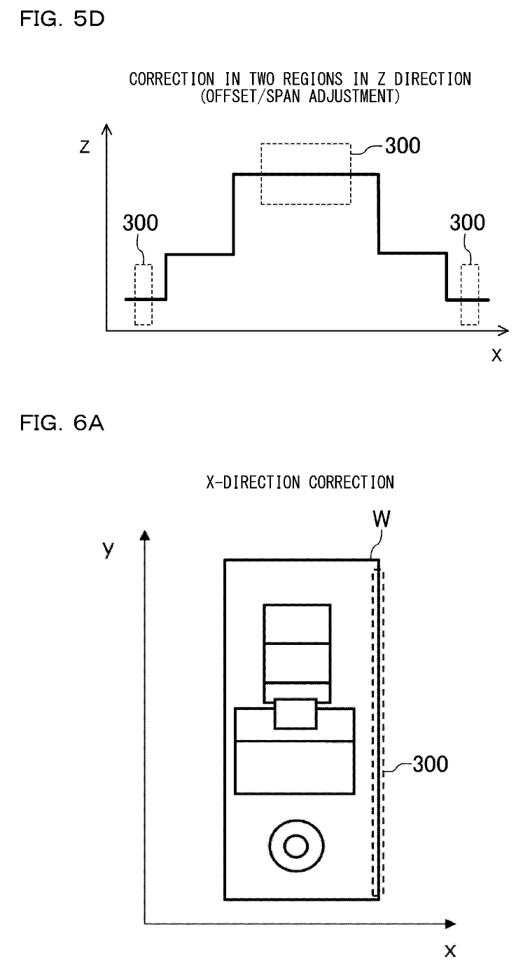

The image to be corrected can be an image after linear correction or a three-dimensional height image. The image to be corrected may be the entire image or may be limited to a characteristic region. The characteristic region may be designated by the user or may be designated by automatic recognition, and FIG. 5A illustrates a case where the user designates the characteristic region with respect to the height profile on the profile image.

As illustrated in FIG. 5A, a characteristic region can be designated on the profile image according to the measuring object W. The characteristic region can be designated on the three-dimensional height image or can be designated on the raw image. Not only one characteristic region but also a plurality of characteristic regions can be designated. When a characteristic region is designated, the user operates the operation unit 7 in a state where the profile image and the three-dimensional height image are displayed on the display unit 6, and performs a designation operation of the characteristic region. The designation operation performed by the user is detected by the correction unit 35.

FIG. 5B illustrates a case where a characteristic region corresponding to the X-direction correction is designated on the profile image. As illustrated in FIG. 5B, the accuracy of the X-direction correction is improved by designating the portion whose shape changes in the Z direction as a characteristic region. As a method of designating a characteristic region, there is a method of surrounding the characteristic region by the user operating a mouse or the like. FIG. 5B illustrates a rectangular object 300 surrounding a characteristic region. For example, a region whose shape change is less than a predetermined value may be presented to the user as a candidate for a characteristic region.

FIG. 5C illustrates a case where one characteristic region corresponding to the Z-direction correction is designated on the profile image. In the case of the Z-direction correction, the accuracy of the Z-direction correction is improved by designating a portion suitable for the offset adjustment in the Z direction and a portion having almost no change in the Z direction as characteristic regions. The method of designating the characteristic region is the same as that in the case illustrated in FIG. 5B.

FIG. 5D illustrates a case where two characteristic regions corresponding to the Z-direction correction are designated on the profile image. A portion having almost no change in the Z direction is designated as a first characteristic region, and in addition to this, a portion having a position different from that of the first characteristic region in the Z direction is designated as a second characteristic region. As a result, it is possible to make both offset adjustment and span adjustment in the Z direction. The method of designating the characteristic region is the same as that in the case illustrated in FIG. 5B.

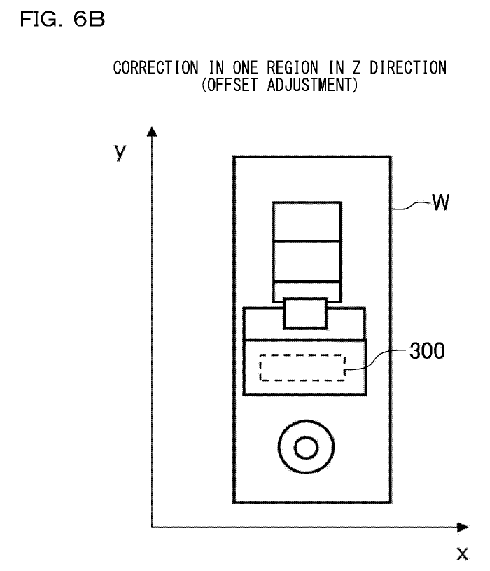

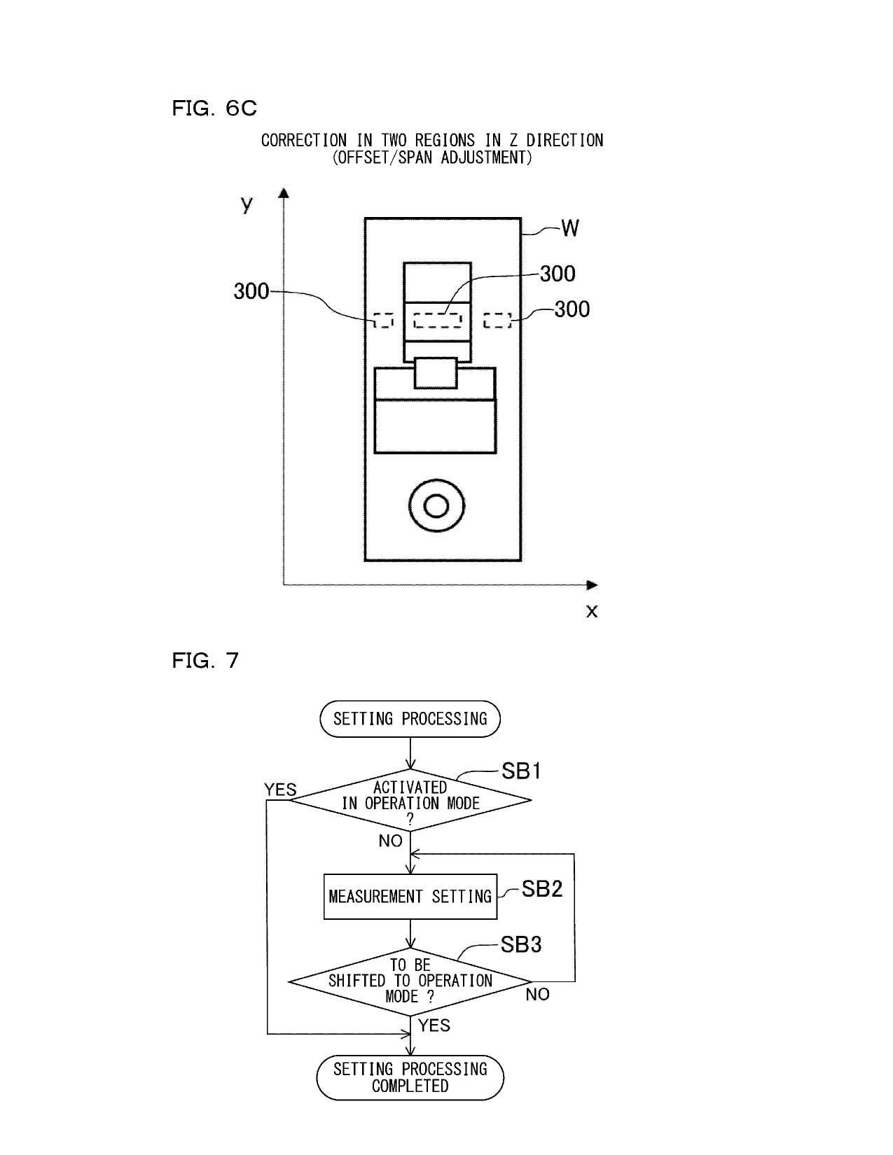

FIG. 6A illustrates a case where a characteristic region corresponding to the X-direction correction is designated on the three-dimensional height image. As illustrated in FIG. 6A, by designating a portion long in the Y direction as a characteristic region, the accuracy of the X-direction correction is improved. The method of designating the characteristic region is the same as that in the case illustrated in FIG. 5B.

FIG. 6B illustrates a case where two characteristic regions corresponding to the Z-direction correction are designated on the three-dimensional height image. As illustrated in FIG. 6B, the accuracy of the X-direction correction is improved by designating the portion having the spread in the XY direction as the characteristic region. The method of designating the characteristic region is the same as that in the case illustrated in FIG. 5B.

FIG. 6C illustrates a case where a plurality of characteristic regions corresponding to the Z-direction correction are designated on the three-dimensional height image. As illustrated in FIG. 6C, a portion extending in the XY direction is designated as a first characteristic region, and in addition to this, a portion having a position in the Z direction different from that of the first characteristic region is designated as a second characteristic region. As a result, it is possible to make both offset adjustment and span adjustment in the Z direction. The method of designating the characteristic region is the same as that in the case illustrated in FIG. 5B.

As illustrated in FIGS. 5B to 5D, in a case where the user designates a characteristic region, that is, a partial region, when the correction unit 35 dynamically corrects the height profile, the correction unit 35 performs the correction, on the basis of the designation of the partial region of the height profile, so that the partial region of the first height profile and the partial region of the second height profile corresponding to the designation are in a positionally-aligned relationship. At the time of this correction, the correction unit 35 corrects, on the basis of the first height profile and the second height profile, at least one of the first height profile or the second height profile such that the first height profile and the second height profile are aligned. Then, the combining unit 36 combines the first height profile and the second height profile that are in a positionally-aligned relationship on the basis of the aligning parameter. The aligning parameter for bringing the first height profile and the second height profile into the positionally-aligned relationship may include only the correction value of the offset in the Z direction or may include the correction value of the offset in the Z direction and the correction value of the span.

In addition, it is possible to acquire each height profile of a plurality of height profiles on the basis of each image capture timing from the acquisition start timing of the height image generated on the basis of the plurality of height profiles. When each height profile of the plurality of height profiles is acquired on the basis of each image capture timing, the correction unit 35 performs correction on the basis of the designation of the partial region of the height image so that the partial region including the image capture timing of the first height profile corresponding to the designation and the partial region including the image capture timing of the second height profile are in a positionally-aligned relationship.

Next, in a case where a characteristic region is automatically recognized, the correction unit 35 acquires a first height profile, light amount information corresponding to the first height profile, a second height profile, and light amount information corresponding to the second height profile. The correction unit 35 specifies partial regions in which the first height profile and the second height profile are aligned on the basis of the first height profile, the light amount information corresponding to the first height profile, the second height profile, and the light amount information corresponding to the second height profile.

Hereinafter, a specific example of processing in the case of automatically recognizing a characteristic region will be described with reference to the flowchart illustrated in FIG. 7. The flowchart illustrated in FIG. 7 is started by an activation operation of the profiler 100. In step SB1, the correction unit 35 determines whether or not the profiler 100 is activated in the operation mode. If not activated in the operation mode, the process proceeds to step SB2, and the correction unit 35 executes measurement setting. In the measurement setting, the correction unit 35 executes automatic recognition processing of a characteristic region. As a point or a region where automatic recognition is performed, a plurality of pieces of profile data exist, and a flat portion or a stepped portion is desirable as the shape of the measuring object W, but the present invention is not limited thereto. As a method of recognizing the flat portion or the step portion of the measuring object W, for example, a rule-based method, a method using a machine-learned model, or a method combining a rule-based model and a machine-learned model may be used. In addition to the correction based on the three-dimensional height image, correction in units of profiles is also possible.

When the measurement setting is completed, the process proceeds to step SB3, and the correction unit 35 determines whether to shift to the operation mode. When shifting to the operation mode, the setting processing is completed. The characteristic region specified by the automatic recognition may be presented to the user.

The correction unit 35 obtains a difference between the amounts of change of the first head unit 2A and the second head unit 2B in the characteristic region designated as described above, and calculates a correction value in units of profiles as an aligning parameter. This aligning parameter is a parameter for bringing the first height profile and the second height profile, which are used for combining by the combining unit, into a positionally-aligned relationship 36. Although the offset and the span in the Z direction are used as the correction value, parameters of X, Z, and θ may be applied. In addition, for example, processing of correcting the position of a characteristic region by a method such as pattern matching may be executed as preprocessing.

In a case where the calculation target is an invalid value or in a case where it is determined that the reliability of the calculated correction value is low, the calculated correction value is invalidated, and the previous value (correction value calculated last time) can be set as the correction value to be applied at the time of combining. That is, when dynamically correcting the aligning parameter on the basis of the first height profile and the second height profile, the correction unit 35 determines the presence or absence of the partial region to be aligned, and maintains the previous value of the aligning parameter when it is determined that there is no partial region to be aligned. As a result, the aligning parameter with low reliability is not applied to the dynamic correction. The invalid value is, for example, a measured value with low reliability due to an insufficient light amount or various filter settings.

Furthermore, in the case of a long measuring object W having no break in the three-dimensional height image, the correction unit 35 obtains an average value of the correction values or a representative value of the correction values for each designated profile. The combining unit 36 applies the average value of the correction values obtained by the correction unit 35 or the representative value of the correction values to the combining processing. Either one of the combined profile data can be selected. Further, the combined profile data can be converted into one profile data by processing such as averaging. Furthermore, the correction unit 35 can also correct the vibration of the measuring object W with respect to the combined profile using the partial region designated by the user.

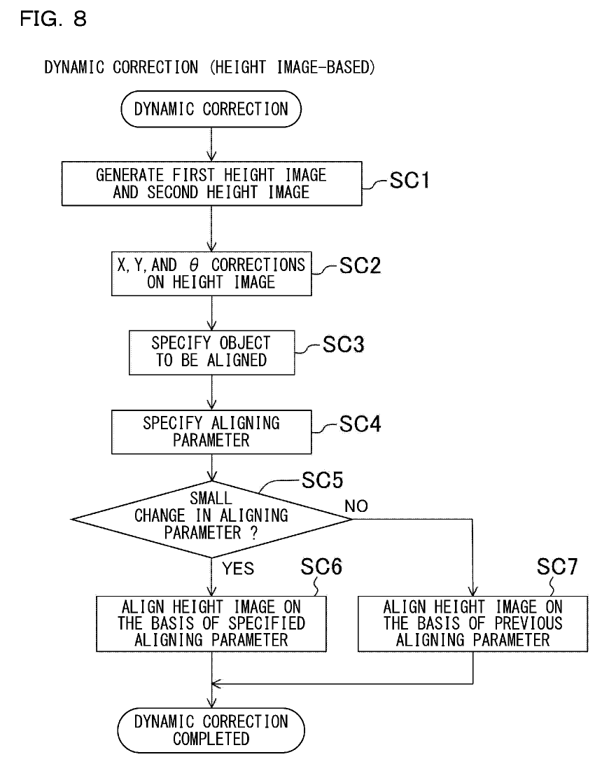

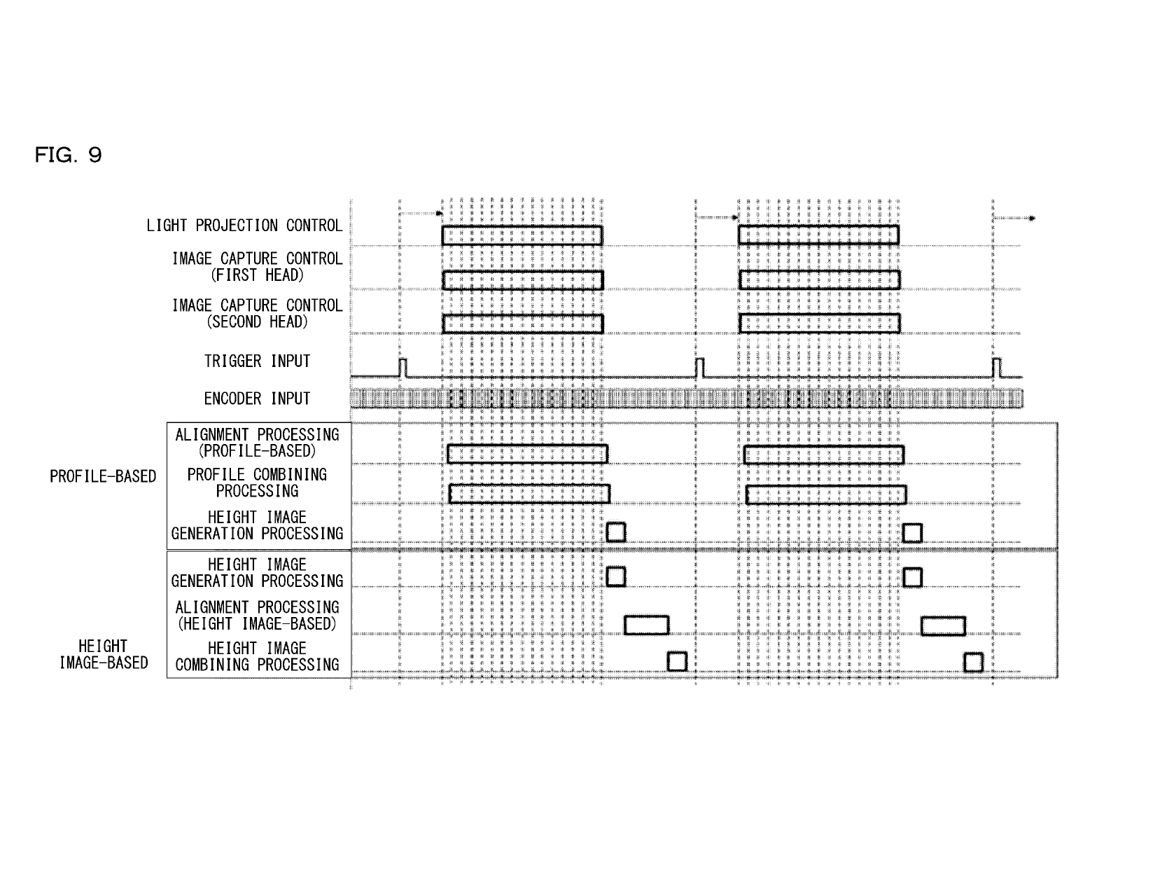

FIG. 8 illustrates a specific example of the dynamic correction processing based on the three-dimensional height image. FIG. 9 is a time chart at the time of operation of the profiler. As illustrated in FIG. 9, the light projection control and the image capture control are executed on the basis of the input of the trigger signal. In step SC1 after the start of the flowchart of FIG. 8, the first 3D image generation unit 33 and the second 3D image generation unit 34 generate the first three-dimensional height image and the second three-dimensional height image. In step SC2, the correction unit 35 performs X, Y, and θ corrections on the first three-dimensional height image and the second three-dimensional height image generated in step SC1.

In step SC3, the correction unit 35 specifies an object to be aligned, that is, a characteristic region on the basis of designation by the user. In step SC4, the correction unit 35 specifies the aligning parameter. In step SC5, the correction unit 35 determines whether or not the change amount of the aligning parameter specified in step SC4 is smaller than a predetermined value. When the change amount of the aligning parameter is smaller than the predetermined value, the process proceeds to step SC6, and the combining unit 36 aligns the three-dimensional height image on the basis of the aligning parameter specified in step SC4. When the change amount of the aligning parameter is equal to or greater than the predetermined value, the process proceeds to step SC7, and the combining unit 36 aligns the three-dimensional height image on the basis of the previous aligning parameter.

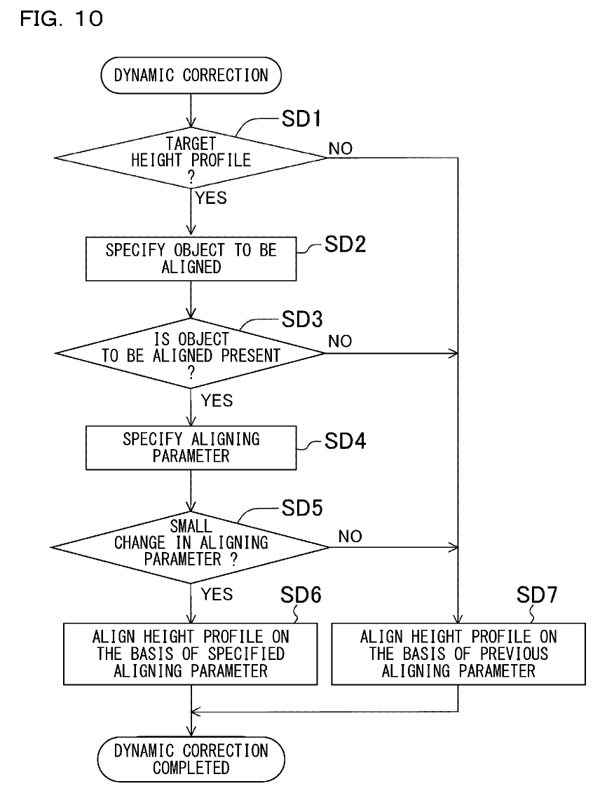

FIG. 10 illustrates a specific example of the dynamic correction processing based on the first height profile and the second height profile. In step SD1 after the start, the correction unit 35 determines whether the height profile is the target height profile. In a case where the height profile is not the target height profile, the processing proceeds to step SD7, and the combining unit 36 aligns the height profile on the basis of the previous aligning parameter. In the case of the target height profile, the processing proceeds to step SD2, and the correction unit 35 specifies an object to be aligned, that is, a characteristic region on the basis of designation by the user. In step SD3, the correction unit 35 determines the presence or absence of an object to be aligned. In a case where there is no object to be aligned, the process proceeds to step SD7. In a case where there is an object to be aligned, the process proceeds to step SD4. In step SD4, the correction unit 35 specifies the aligning parameter.

In step SD5, the correction unit 35 determines whether or not the change amount of the aligning parameter specified in step SD4 is smaller than a predetermined value. When the change amount of the aligning parameter is smaller than the predetermined value, the process proceeds to step SD6, and the combining unit 36 aligns the height profile on the basis of the aligning parameter specified in step SD4. When the change amount of the aligning parameter is equal to or larger than the predetermined value, the process proceeds to step SD7. As described above, on the basis of the first height profile and the second height profile, the correction unit 35 can dynamically correct the aligning parameter for bringing the first height profile and the second height profile, which are used for combining by the combining unit, into a positionally-aligned relationship 36, and can also correct at least one of the first height profile or the second height profile on the basis of the aligning parameter. Furthermore, when the correction unit 35 performs dynamic correction, the correction is performed such that partial regions (characteristic regions) specified by the user are in a positionally-aligned relationship.

The correction unit 35 can execute the dynamic correction described above and the precise correction using the predetermined shape tool. That is, the profiler 100 not only linearly corrects in advance the deviation in the measurement results due to the temperature or the change with time, but also includes a precise correction unit as a unit for periodically correcting the deviation by the user. In the precise correction, a predetermined shape tool is used as a dedicated workpiece for correction. By measuring the predetermined shape tool with the first head unit 2A and the second head unit 2B, it is possible to accurately detect the misalignment of the optical systems or the like of the first head unit 2A and the second head unit 2B. The correction unit 35 creates or corrects a parameter for calculating a profile, such as linear correction data, so as to eliminate the misalignment detected using the predetermined shape tool.

Since the dynamic correction needs to reflect the result in real time, there is a large restriction on the processing time. On the other hand, since the static correction has a small restriction on the processing time, more detailed parameters can be calculated and reflected. The linear correction performed in advance, the precise correction statically performed by the user, and the dynamic correction differ from each other in the aligning parameter to be corrected. For example, the correction unit 35 corrects a parameter used for profile calculation by precise correction, and corrects a value of the profile by dynamic correction. More specifically, the correction unit 35 corrects the optical system parameter by precise correction.

### Second embodiment

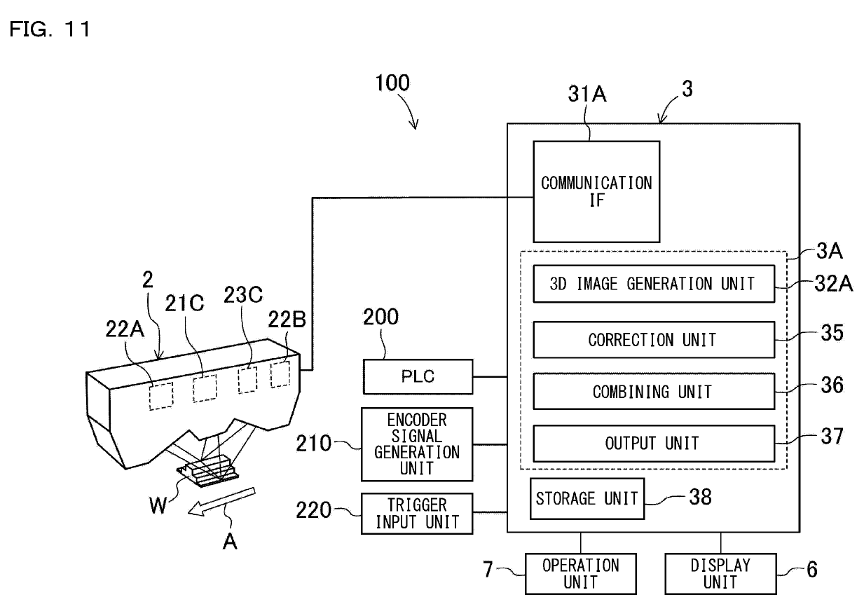

FIG. 11 illustrates a profiler 100 according to a second embodiment of the present invention. The profiler 100 of the second embodiment is different from that of the first embodiment in that it includes a single measurement head 2, and other parts are the same as those of the first embodiment. Therefore, in the following description, the same parts as those of the first embodiment are denoted by the same reference numerals, description thereof is omitted, and different parts will be described.

The measurement head 2 includes a light projection unit 21C that projects line light as measurement light to the measuring object W, a first light receiving unit 22A, a second light receiving unit 22B, and a profile generator 23C. The first light receiving unit 22A and the second light receiving unit 22B are arranged side by side in the conveyance direction A, and capture an image of the measurement light in directions different from each other so as to capture the image of the measurement light in two directions.

The profile generator 23C generates a first height profile indicating the cross-sectional shape of the measuring object W based on the detection data acquired by the first light receiving unit 22A, and generates a second height profile indicating the cross-sectional shape of the measuring object W based on the detection data acquired by the second light receiving unit 22B.

The first height profile data and the second height profile data are transmitted to the communication interface 31A of the controller unit 3. The 3D image generation unit 33A of the controller unit 3 generates a three-dimensional height image on the basis of the first height profile data, and generates a three-dimensional height image on the basis of the second height profile data.

In the second embodiment, the correction unit 35 and the combining unit 36 operate similarly to the first embodiment.

The above-described embodiments are merely examples in all respects, and should not be construed in a limiting manner. Further, all modifications and changes falling within the equivalent scope of the claims are within the scope of the present invention.

For example, the profiler 100 may include a generation unit including a first profile generator 23A and a second profile generator 23B as a generation unit that generates the first height profile on the basis of the image of the measurement light captured by the first light receiving unit 22A and generates the second height profile on the basis of the image of the measurement light captured by the second light receiving unit 22B.

In this case, the correction unit 35 acquires the first height profile and the second height profile generated by the generation unit including the first profile generator 23A and the second profile generator 23B. The correction unit 35 dynamically corrects, on the basis of the acquired first height profile and second height profile, at least one of the first height profile or the second height profile so that the first height profile and the second height profile are in a positionally-aligned relationship, and thus generates an aligned first height profile and an aligned second height profile.

In addition to combining the first height profile and the second height profile before being dynamically corrected by the correction unit 35, the combining unit 36 can acquire the aligned first height profile and the aligned second height profile generated by the correction unit 35, and combine the aligned first height profile and the aligned second height profile.

In addition to being able to output at least one of the first height profile or the second height profile before being dynamically corrected by the correction unit 35, the output unit 37 can also acquire at least one of the aligned first height profile or the aligned second height profile generated by the correction unit 35 and output at least one of the aligned first height profile and the aligned second height profile. In this case, the output unit 37 outputs at least one of the aligned first height profile or the aligned second height profile before being combined by the combining unit 36. The output unit 37 may output both the aligned first height profile and the aligned second height profile before being combined by the combining unit 36, may output only the aligned first height profile, or may output only the aligned second height profile.

As described above, the profiler according to the present disclosure can be used to generate height profiles of various measuring objects.

What is claimed is:

1. A profiler that projects line light as measurement light and generates a height profile on the basis of an image obtained by capturing an image of the measurement light, the profiler comprising:
a light projection unit configured to project the line light as the measurement light;
a first imaging element and a second imaging element configured to capture the measurement light in directions different from each other;
a generation unit configured to generate a first height profile on the basis of an image of the measurement light captured by the first imaging element and generate a second height profile on the basis of an image of the measurement light captured by the second imaging element; and
a correction unit configured to, on the basis of the first height profile and the second height profile generated by the generation unit, dynamically correct at least one of the first height profile or the second height profile such that the first height profile and the second height profile are in a positionally-aligned relationship, and thus to generate an aligned first height profile and an aligned second height profile.

2. The profiler according to claim 1, further comprising
a combining unit configured to combine the aligned first height profile and the aligned second height profile generated by the correction unit.

3. The profiler according to claim 1, further comprising
an output unit configured to output at least one of the aligned first height profile and the aligned second height profile generated by the correction unit.

4. The profiler according to claim 1, wherein
on the basis of designation of a partial region of the height profile, the correction unit performs correction so that a partial region of the first height profile and a partial region of the second height profile corresponding to the designation are in the positionally-aligned relationship when the dynamic correction is performed.

5. The profiler according to claim 4, wherein
when acquiring each height profile of a plurality of height profiles on the basis of each image capture timing from acquisition start timing of a three-dimensional height image generated on the basis of the plurality of height profiles, the correction unit corrects, on the basis of designation of a partial region of the three-dimensional height image, such that a partial region including the image capture timing of the first height profile and a partial region including the image capture timing of the second height profile corresponding to the designation are in a positionally-aligned relationship.

6. The profiler according to claim 1, wherein
the correction unit corrects, on the basis of the first height profile and the second height profile, at least one of the first height profile or the second height profile such that the first height profile and the second height profile are aligned.

7. The profiler according to claim 2, wherein
the correction unit dynamically corrects, on the basis of the first height profile and the second height profile, an aligning parameter for bringing the first height profile and the second height profile, which are used for combining by the combining unit, into a positionally-aligned relationship, and corrects at least one of the first height profile or the second height profile on the basis of the aligning parameter.

8. The profiler according to claim 1, wherein
the correction unit specifies a partial region in which the first height profile and the second height profile are aligned on the basis of the first height profile, light amount information corresponding to the first height profile, the second height profile, and light amount information corresponding to the second height profile, and performs correction so that the specified partial regions are in a positionally-aligned relationship when the dynamic correction is performed.

9. The profiler according to claim 2, wherein
the correction unit dynamically corrects, on the basis of the first height profile and the second height profile, an aligning parameter for bringing the first height profile and the second height profile, which are used for combining by the combining unit, into a positionally-aligned relationship, and
the combining unit combines the first height profile and the second height profile that are in a positionally-aligned relationship on the basis of the aligning parameter.

10. The profiler according to claim 9, wherein
the aligning parameter includes a correction value of an offset in a Z direction.

11. The profiler of claim 9, wherein
the aligning parameter comprises a span correction value.

12. The profiler according to claim 9, wherein
the correction unit performs precise correction using a predetermined shape tool and the dynamic correction.

13. The profiler according to claim 12, wherein
the correction unit corrects different aligning parameters between the precise correction and the dynamic correction.

14. The profiler according to claim 13, wherein
the correction unit corrects a parameter used for profile calculation by the precise correction and corrects a value of the profile by the dynamic correction.

15. The profiler according to claim 13, wherein
the correction unit corrects an optical system parameter by the precise correction.

16. The profiler according to claim 9, wherein
the correction unit dynamically corrects, on the basis of the three-dimensional height image, an aligning parameter for bringing the first height profile and the second height profile, which are used for combining by the combining unit, into the positionally-aligned relationship.

17. The profiler according to claim 9, wherein
when dynamically correcting the aligning parameter on the basis of the first height profile and the second height profile, the correction unit maintains a previous value of the aligning parameter when there is no partial region to be aligned.

18. The profiler according to claim 9, wherein
the correction unit corrects vibration of the measuring object with respect to the combined profile using a partial region designated by a user.

19. The profiler according to claim 9, further comprising
an output unit that outputs the height profile combined by the combining unit, the first height profile, and the second height profile.
